(19) United States
(12) Patent Application Publication
(10) Pub. No.: US 2015/0254391 A1
(43) Pub. Date: Sep. 10, 2015

(54) METHOD AND DESIGN APPARATUS AND COMPUTER-READABLE RECORDING MEDIUM

(71) Applicant: Kabushiki Kaisha Toshiba, Minato-Ku (JP)

(72) Inventors: Ai OMODAKA, Yokkaichi-Shi (JP); Soh KOIKE, Yokkaichi-Shi (JP)

(73) Assignee: KABUSHIKI KAISHA TOSHIBA, Minato-Ku (JP)

(21) Appl. No.: 14/293,302

(22) Filed: Jun. 2, 2014

Related U.S. Application Data
(60) Provisional application No. 61/948,172, filed on Mar. 5, 2014.

(51) Int. Cl. G06F 17/50

(52) U.S. Cl. CPC G06F 17/5081; G06F 17/5077

(57) ABSTRACT

In accordance with an embodiment, a design method includes classifying interconnection line patterns each including a space between interconnection lines among design layout patterns of a semiconductor element with an air gap between the interconnection lines, on the basis of characteristics of the space, acquiring a basic amount of the classified interconnection line pattern, predicting a position where each air gap is highest and a height of the position for each classified interconnection line pattern, and suitably adjusting the arrangement of the interconnection lines in the design layout pattern in accordance with the predicted position and height. The basic amount is acquired from a shape of the classified interconnection line pattern. The position where each air gap is highest and the height of the position are predicted by collating data of a correlation between the width of the space and the height of the air gap with the basic amount.

### CROSS REFERENCE TO RELATED APPLICATIONS

This application is based upon and claims the benefit of U.S. provisional Application No. 61/948,172, filed on Mar. 5, 2014, the entire contents of which are incorporated herein by reference.

### FIELD

Embodiments described herein relate generally to a design method, a design apparatus and a computer-readable recording medium.

### BACKGROUND

In a semiconductor element, an air gap is sometimes disposed between interconnection lines for the purpose of reducing a capacity between the interconnection lines, or the like.

However, the interconnection lines of a semiconductor device are arranged further finely and intricately, and hence it is difficult to appropriately dispose the air gap.

### BRIEF DESCRIPTION OF THE DRAWINGS

In the accompanying drawings:

FIG. 1 is a flowchart explaining a schematic procedure of a design method according to one embodiment;

FIG. 2 is a view showing one example of an interconnection line pattern;

FIG. 3A to FIG. 3E are views showing several examples of interconnection line patterns classified in accordance with the procedure shown in FIG. 1;

FIG. 4A to FIG. 4E are views each explaining one example of an acquiring method of a basic amount for each of the interconnection line patterns;

FIG. 5 is a view showing one example of a shape simulation result;

FIG. 6 is a graph showing one example of data of a correlation between a space width and a height of an air gap, which is obtained in accordance with the procedure shown in FIG. 1;

FIG. 7 is a view showing one example of a positional relation between each highest point obtained for the interconnection line pattern shown in FIG. 2 and the interconnection line pattern, which is obtained in accordance with the procedure shown in FIG. 1;

FIG. 8 is a view showing one example where the interconnection line pattern shown in FIG. 2 is modified in accordance with the procedure shown in FIG. 1;

FIG. 9 is a view where one example of an upper layer pattern which passes above the interconnection line pattern shown in FIG. 2 is added to FIG. 2;

FIG. 10 is a graph showing one example of a case where a position of a depth of the upper layer pattern shown in FIG. 9 is added to the data of the correlation shown in FIG. 6;

FIG. 11 is a view showing one example where the arrangement of the upper layer pattern shown in FIG. 9 is modified in accordance with the procedure shown in FIG. 1;

FIG. 12 is a view where one example of a contact pattern arranged on the interconnection line pattern shown in FIG. 2 is added to FIG. 2;

FIG. 13 is a view showing one example where the arrangement of the contact pattern shown in FIG. 12 is modified in accordance with the procedure shown in FIG. 1; and

FIG. 14 is a block diagram explaining a schematic constitution of a design apparatus according to one embodiment.

### DETAILED DESCRIPTION

In accordance with an embodiment, a design method includes classifying interconnection line patterns each including a space between interconnection lines among design layout patterns of a semiconductor element with an air gap between the interconnection lines, on the basis of characteristics of the space, acquiring a basic amount of the classified interconnection line pattern, predicting a position where each air gap is highest and a height of the position for each classified interconnection line pattern, and suitably adjusting the arrangement of the interconnection lines in the design layout pattern in accordance with the predicted position and height. The basic amount is acquired from a shape of the classified interconnection line pattern. The position where each air gap is highest and the height of the position are predicted by collating data of a correlation between the width of the space and the height of the air gap with the basic amount.

Embodiments will now be explained with reference to the accompanying drawings. Like components are provided with like reference signs throughout the drawings and repeated descriptions thereof are appropriately omitted. It is to be noted that the accompanying drawings illustrate the invention and assist in the understanding of the illustration and that the shapes, dimensions, and ratios and so on in each of the drawings may be different in some parts from those in an actual apparatus. For these differences, a skilled person could make proper modifications in design by reference to the following explanations and known arts.

(1) Design Method

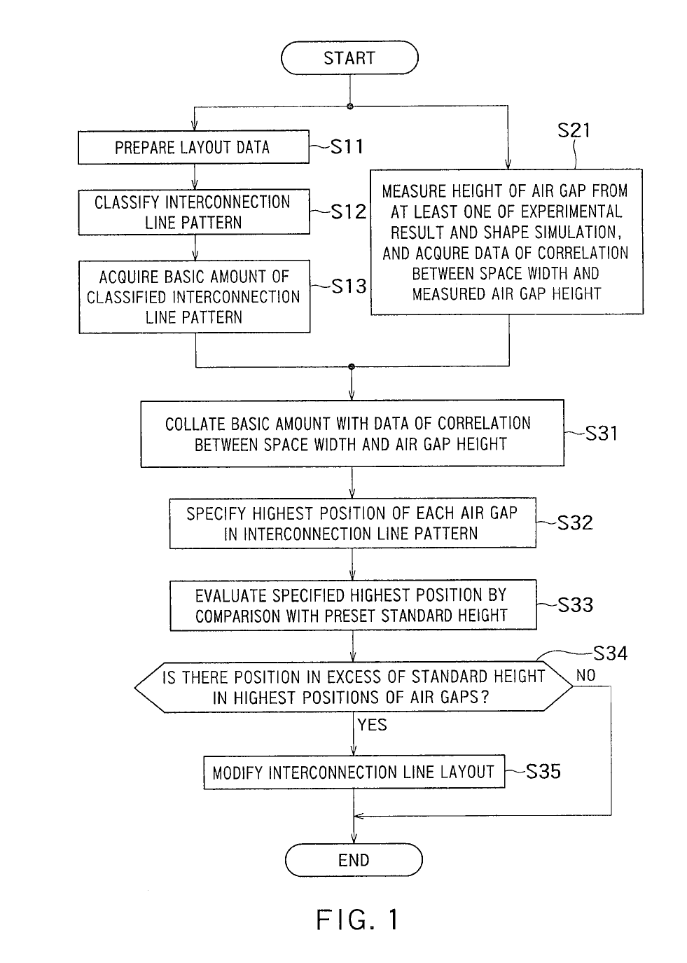

FIG. 1 is a flowchart explaining a schematic procedure of a design method of a semiconductor element according to one embodiment.

First, there is prepared design layout data of the semiconductor element in which an air gap is formed between interconnection lines (step S11).

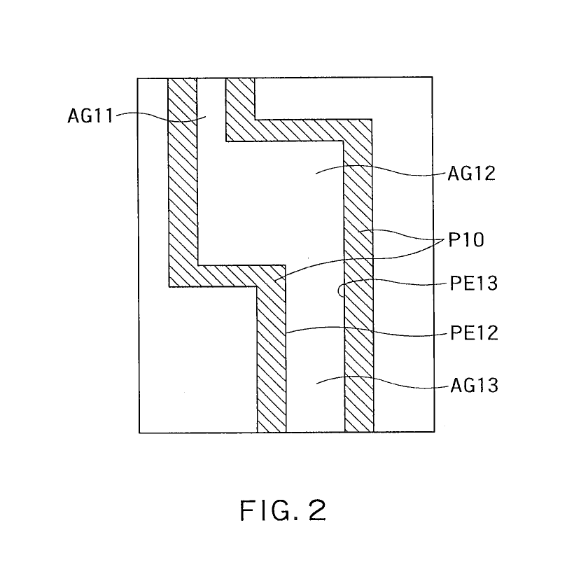

FIG. 2 is a view showing one example of interconnection line patterns in the prepared design layouts. It is predicted that in an interconnection line pattern P10 shown in FIG. 2, portions having different space widths are present between pattern edges PE12 and PE13, and air gaps AG11, AG12 and AG13 are formed from the upside of the sheet of FIG. 2, respectively.

Next, the interconnection line patterns in the design layouts are classified on the basis of characteristics of space shapes (step S12).

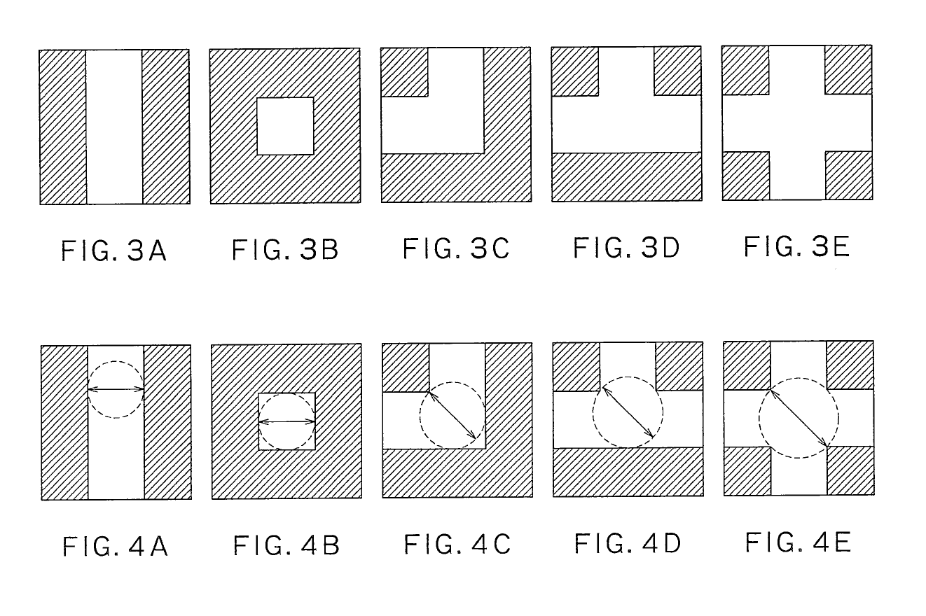

Examples of the classified interconnection line patterns are shown in FIG. 3A to FIG. 3E. The pattern shown in FIG. 3A is one example of a line and space pattern, and the pattern shown in FIG. 3B is a pattern in which a rectangular hole is formed. Furthermore, in the patterns shown in FIG. 3C to FIG. 3E, spaces of an L-shape, a T-shape (a three-forked road) and a crossroad are formed, respectively.

Next, a basic amount of each classified interconnection line pattern is acquired (step S13). Here, the basic amount indicates a numerical quantity which is basic data to predict each space width to be formed in manufacturing steps of the semiconductor element. One example of such a basic amount is a size of an inscribed circle which comes in contact with the pattern edges facing the space in each interconnection line pattern.

FIG. 4A to FIG. 4E are views each depicting the inscribed circle which comes in contact with at least two points of the pattern edges facing the space in each of the interconnection line patterns shown in FIG. 3A to FIG. 3E. In the present embodiment, a radius of each inscribed circle is acquired as the basic amount.

Next, a height of each air gap is measured from at least one of an actual sample obtained as a result of an experiment and of a shape simulation, and data of a correlation between the space width and the measured air gap height is acquired (step S21).

As the actual sample, there may be used a sample obtained during the experiment in which, for example, the space width of the line and space pattern is arbitrarily set to form an air gap forming film, after conditions of an air gap forming process are acquired.

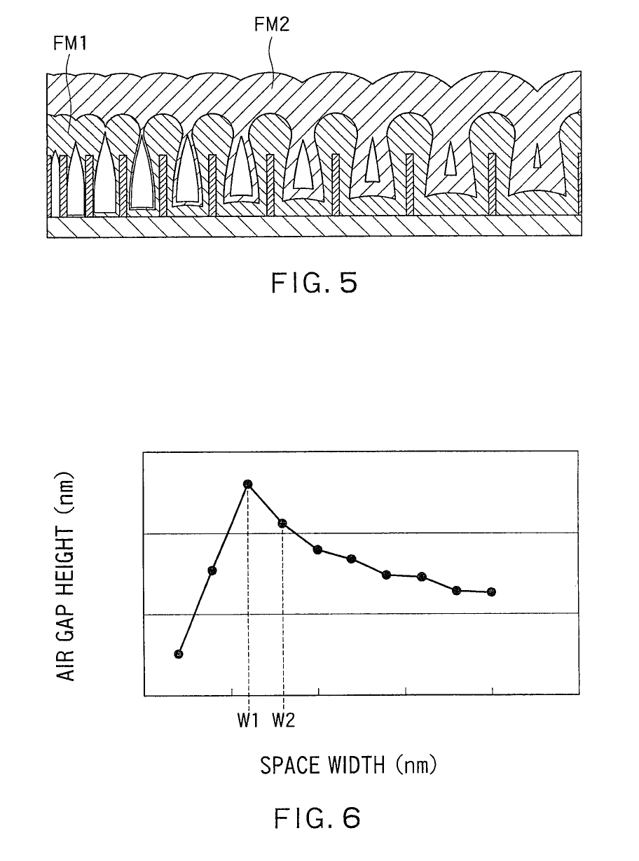

The shape simulation may be carried out by arbitrarily setting, for example, the space width of the line and space pattern to predict the formation of the air gap forming film, after the conditions of the air gap forming process are similarly acquired. An example of a shape obtained by such a simulation is shown in FIG. 5. In the shape shown in FIG. 5, as an air gap forming film FM1 of a first layer, a plasma enhanced chemical vapor deposition (PECVD) film is used, and as an air gap forming film FM2 of a second layer, a low pressure chemical vapor deposition (LPCVD) film is used.

FIG. 6 is a graph showing one example of the data of the correlation between the space width and the height of the air gap which is obtained in the step S21. In the example shown in FIG. 6, the air gap height increases at a constant ratio up to a space width W1. However, it is seen that when the space width is in excess of W1, the height rapidly decreases, and when the space width is in excess of W2, the height slowly decreases.

It is to be noted that in the above description, after the basic amount of each classified pattern is acquired, and then the data of the correlation between the space width and the air gap is acquired. However, as shown in parallel in the flowchart of FIG. 1, an order is not limited to the order of the above description. Specifically, the correlation data may first be acquired and then the basic amount may be acquired, or the acquisition of the correlation data may simultaneously be performed in parallel with the acquisition of the basic amount.

Next, the basic amount obtained in the step S12 is collated with the correlation data acquired in the step S12 (step S31), and the highest position of each air gap formed in the interconnection line pattern is specified (step S32). More specifically, the basic amount obtained in the step S12 is regarded as the space width, and the air gap height in the correlation data which corresponds to each regarded space width is specified as the position where each air gap is highest.

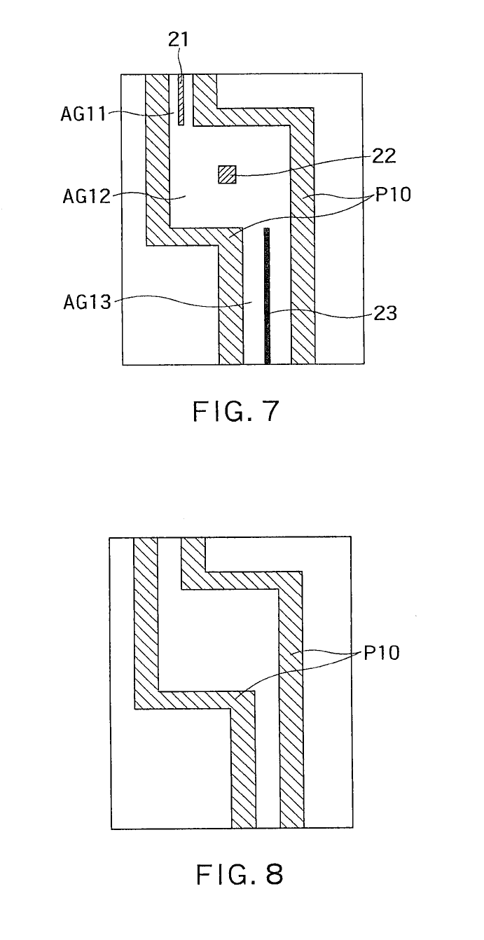

FIG. 7 is a view showing one example of a positional relation between each of the highest points 21 to 23 obtained for each of the air gaps AG11 to AG13 in the interconnection line pattern P10 shown in FIG. 2 and the interconnection line pattern P10.

Subsequently, the respective specified highest positions are evaluated by comparison with a preset standard height (step S33). When there is the highest position in excess of the preset standard height, the position is preferably shown in a visible manner. For example, as shown by a solid portion in FIG. 7, the highest point 23 is in excess of the standard height, and hence the point is preferably displayed in color different from that of the other highest points 21 and 22.

Next, when it is evaluated that there is the highest position in excess of the standard height in the air gap highest positions, i.e., there is the highest position that does not satisfy an evaluation standard (step S34, YES), an interconnection line layout is modified (step S35).

For example, as shown in FIG. 7, when it is evaluated that the inappropriate highest point 23 is present, space widths of portions of the pattern edges PE12 and PE13 facing the air gap AG13 are narrowed to perform the modification, for example, as an interconnection line pattern P10 shown in FIG. 8, so that it is possible to provide the semiconductor element having the air gap of the appropriate height.

The modification of the interconnection line layout in the step S35 may be processed by modifying, instead of the interconnection lines forming the air gap, an interconnection line above the interconnection lines.

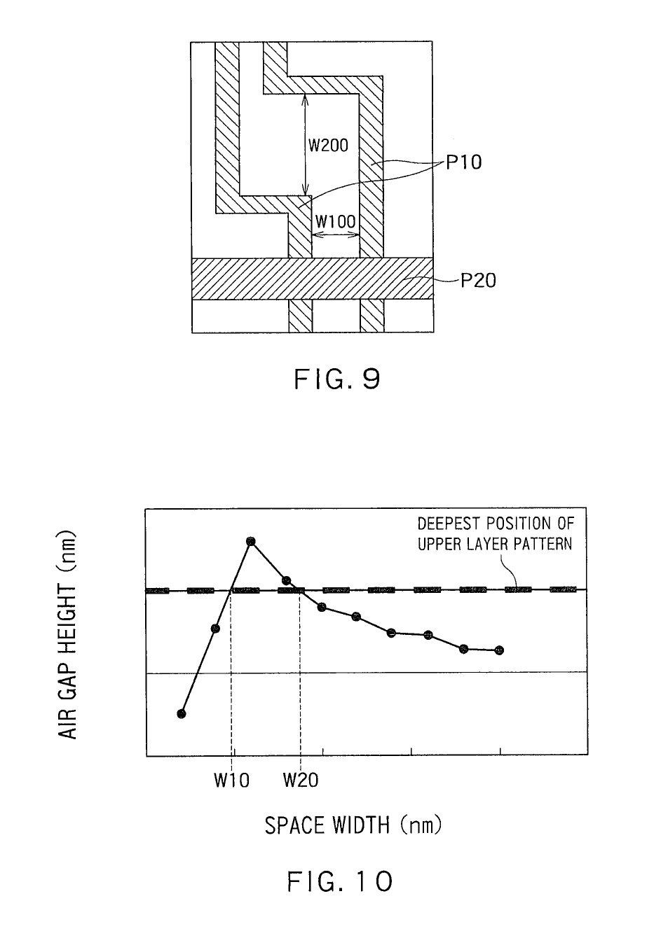

For example, in addition to the interconnection line pattern P10 shown in FIG. 2, FIG. 9 also shows an interconnection line pattern P20 as one example of an upper layer pattern which passes above the interconnection line pattern P10. Furthermore, FIG. 9 clearly shows space widths in the interconnection line pattern P10.

FIG. 10 shows one example of a case where, at this time, the deepest position of the upper layer interconnection line pattern P20, i.e., a position of a surface (a bottom surface) of the interconnection line pattern P20 on the side of the interconnection line pattern P10 is added to the data indicating the correlation between the space width and the air gap height shown in FIG. 6.

As seen from the graph of FIG. 10, when the upper layer interconnection line pattern P20 passes above a region where a space width is from W10 to W20 in a region of the interconnection line pattern P10, there is admitted the presence of an air gap through which the upper layer interconnection line pattern P20 passes. As seen from FIG. 9, an interconnection line region of a space width W100 (W10<W100<W20) is present under the upper layer interconnection line pattern P20, and it is predicted that the upper layer interconnection line pattern P20 passes through the air gap AG13 to cause a defect.

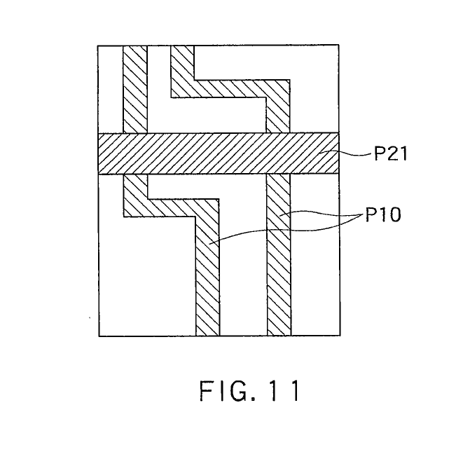

Thus, when the upper layer pattern P20 is rearranged as much as possible, the defect can be avoided. Here, for example, as shown in FIG. 11, when the arrangement of the upper layer interconnection line pattern P20 is modified in such a manner that an interconnection line pattern P21 is present above a region of a space width W200 (>W20) in the region of the interconnection line pattern P10, passing through the air gap AG12 can be avoided.

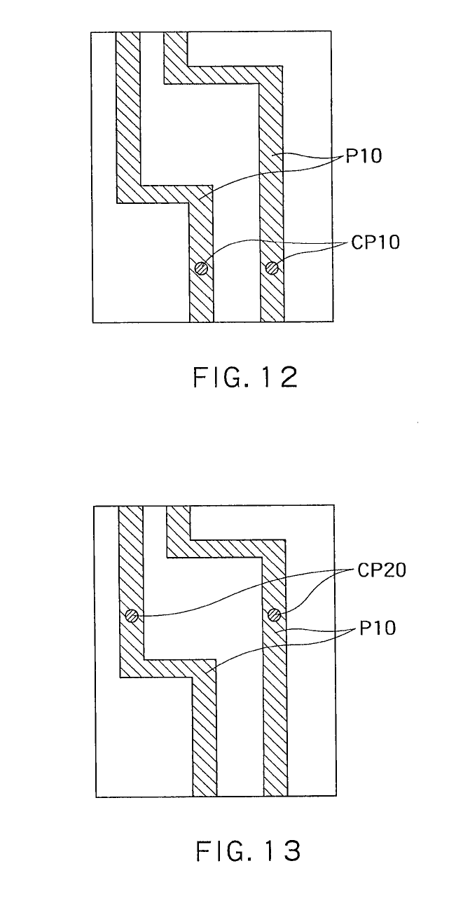

With reference to FIG. 9 and FIG. 11, the upper layer interconnection line pattern P20 has been described, but the modification is not limited to the interconnection line pattern. For example, as shown in FIG. 12 and FIG. 13, modification processing can similarly be performed for contact holes CP20 and CP21.

Needless to say, the design method of the present embodiment is also effective in a case where the PECVD film is only used as the air gap forming film. However, as described above, in a process in which the air gap is once formed by the PECVD film and a region such as a peripheral circuit portion of a large space is filled with the LPCVD film to form the air gap, the air gap is reduced by the invasion of the LPCVD film, in a case where there is a space larger than a predetermined width. When the height and a transverse width of the air gap are predicted in consideration of such filling with the LPCVD film, the design method of the present embodiment is especially effective.

According to the design method of at least one embodiment described above, the position and height of the air gap are predicted by collating the basic amount of the interconnection line pattern classified on the basis of the characteristics of the shape with the data of the correlation between the space width and the air gap height. Therefore, a processing time can be shortened, and the defect caused by the air gap can be avoided in advance, so that delay of a development period can be inhibited.

(2) Design Apparatus

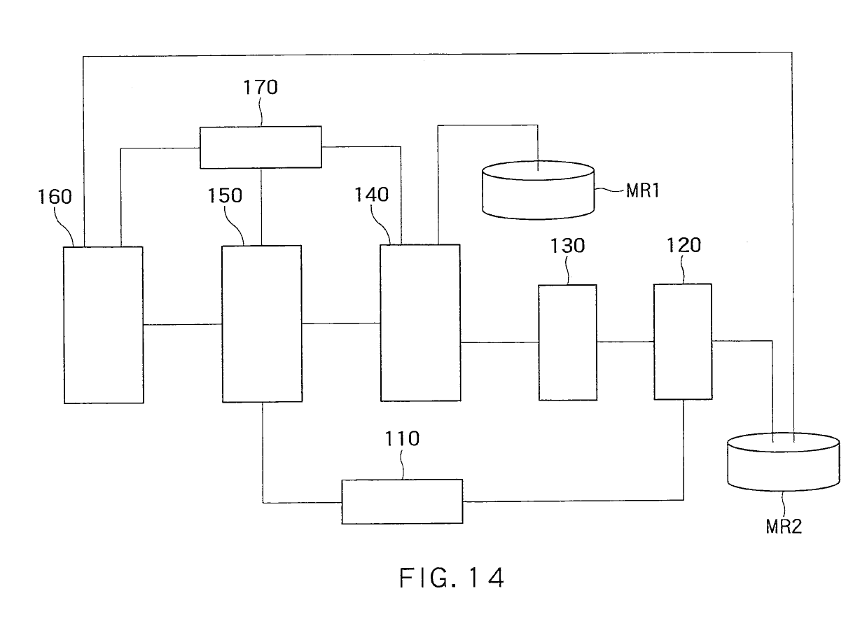

A design apparatus according to one embodiment will be described with reference to FIG. 14. FIG. 14 is a block diagram explaining a schematic constitution of the design apparatus of the present embodiment.

The design apparatus of the present embodiment comprises an input unit 110, a classification unit 120, a basic amount acquisition unit 130, a prediction unit 140, an evaluation unit 150, a design layout change unit 160, a display unit 170, and memory devices MR1 and MR2.

The input unit 110 is an interface to input evaluation standard data or the like for evaluation of the highest position of each air gap predicted by the prediction unit 140 in addition to design layout data of a semiconductor element as a design object. The input design layout data is stored in the memory device MR2 via the classification unit 120, and the input evaluation standard data is given to the evaluation unit 150.

The memory device MR1 stores data of a correlation between a space width and a height of the air gap which is acquired from an actual sample obtained as a result of an experiment or from a shape simulation. As the actual sample, for example, there is used a sample obtained by the experiment in which the space width of a line and space pattern is arbitrarily set, and then an air gap forming film is formed in accordance with conditions of an air gap forming process.

In the present embodiment, there will be described a configuration where the height of the air gap is beforehand measured from at least one of the actual sample and the shape simulation, and the data of the correlation between the space width and the measured air gap height is stored in the memory device MR1. However, the present invention is not limited to this configuration. For example, a simulator (not shown) may further be included in the design apparatus, and the conditions of the air gap forming process and the design layout data may be taken into this simulator, whereby the simulation may be performed by the design apparatus itself.

The classification unit 120 takes the design layout data from the memory device MR2, classifies interconnection line patterns in design layouts on the basis of characteristics of space shapes of the interconnection line patterns (see FIG. 3A to FIG. 3E), and sends classification results to the basic amount acquisition unit 130.

The basic amount acquisition unit 130 acquires a basic amount of each of the interconnection line patterns classified by the classification unit 120. In the present embodiment, the basic amount acquisition unit 130 acquires, as the basic amount, a radius of an inscribed circle (see FIG. 4A to FIG. 4E) which comes in contact with at least two points of pattern edges facing a space in each of the classified interconnection line patterns. The basic amount acquisition unit 130 gives the acquired basic amounts to the prediction unit 140.

The prediction unit 140 takes, from the memory device MR1, the data of the correlation between the space width and the air gap (see FIG. 6 and FIG. 10), and collates this correlation data with each basic amount sent from the basic amount acquisition unit 130, to predict the highest position of each air gap formed in the interconnection line pattern and a height of the highest position. The prediction unit 140 sends a prediction result to the evaluation unit 150, and also sends the result to the display unit 170 in such a manner that the result is displayed in a visible manner.

The evaluation unit 150 evaluates the height of each highest position sent from the evaluation unit 150 by comparing the height with a standard height input as preset evaluation standard data from the input unit 110, and the unit allows the display unit 170 to display the evaluation result.

Furthermore, as the result of the evaluation, when an air gap having its maximum height in excess of the standard height is present, the evaluation unit 150 gives the evaluation result to the design layout change unit 160, and also instructs the display unit 170 to display the corresponding portion so as to clearly distinguish the portion from the other portions satisfying the evaluation standard, for example, by changing a display color (see a solid portion of FIG. 7).

The design layout change unit 160 modifies an interconnection line layout in accordance with the evaluation result given from the evaluation unit 150 to suitably adjust the arrangement of interconnection lines, and allows the display unit 170 to display a modification result. Examples of a suitably adjusting method include a method in which space widths of portions facing an air gap are narrowed in such a manner that the maximum height of the air gap falls in a desirable standard range (see FIG. 8), and a method in which a position of an upper layer interconnection line pattern or a contact pattern is changed (see FIG. 11 and FIG. 13) to avoid a defect.

The design apparatus according to at least one embodiment described above includes the classification unit 120 which classifies the interconnection line patterns on the basis of the characteristics of the space shapes, the basic amount acquisition unit 130 which acquires the basic amount of each of the classified interconnection line patterns, and the prediction unit 140 which predicts the highest position of the air gap and the height of the highest position by collating the acquired basic amount with the data of the correlation between the space width and the air gap height. In consequence, it is possible to provide the design apparatus in which the defect caused by the air gap can beforehand be avoided in a short processing time and delay of a development period can be inhibited.

(3) Program

The above-mentioned series of design may be incorporated into a program which may be read and executed by a general-purpose computer. In consequence, the design of a semiconductor element can be realized by using the general-purpose computer, without using the above-mentioned exclusive design apparatus.

Furthermore, the above-mentioned series of design procedures may be incorporated into a program to be executed by a computer, and the program may be stored in a recording medium such as a flexible disc or a CD-ROM and may be read and executed by the computer. The recording medium is not limited to a portable medium such as a magnetic disc or an optical disc, and may be a stationary recording medium such as a hard disk drive or a memory. Furthermore, the program into which the above-mentioned series of design procedure is incorporated may be distributed via a communication line such as internet (including radio communication). Furthermore, the program into which the above-mentioned series of design procedure is incorporated may be distributed via a communication line such as the internet, or the radio communication, or may be stored in the recording medium and then distributed, in an encrypted state, a modulated state, or a compressed state. The recording medium may be temporary or non-temporary.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A design method comprising:
classifying interconnection line patterns each comprising a space between interconnection lines among design layout patterns of a semiconductor element with an air gap between the interconnection lines, on the basis of characteristics of the space;
acquiring a basic amount of the classified interconnection line pattern from a shape of the classified interconnection line pattern;
collating data of a correlation between a width of the space and a height of the air gap with the basic amount, to predict a position where each air gap is highest and a height of the position for each classified interconnection line pattern; and
suitably adjusting the arrangement of the interconnection lines in the design layout pattern in accordance with the predicted position and height.

2. The method of claim 1,
wherein the basic amount is acquired by using a size of an inscribed circle which comes in contact with at least two points of pattern edges of the interconnection lines facing each other via the space.

3. The method of claim 1,
wherein the data of the correlation is acquired by measuring the width of the space and the height of the air gap from at least one of an experimental result and a simulation result.

4. The method of claim 1, further comprising:
evaluating the predicted height on the basis of a preset standard,
wherein the arrangement of the interconnection lines in the design layout pattern is suitably adjusted when the predicted height does not satisfy the standard.

5. The method of claim 4,
wherein the arrangement of the interconnection lines in the design layout pattern is suitably adjusted by changing the width of the space, when it is evaluated that the predicted height does not satisfy the standard.

6. The method of claim 4,
wherein the design layout pattern comprises an upper layer pattern passing above the predicted position, and
the arrangement of the interconnection lines in the design layout pattern is suitably adjusted by moving the upper layer pattern to a position where its contact with the air gap is avoidable, when it is evaluated that the predicted height does not satisfy the standard.

7. The method of claim 6,
wherein the upper layer pattern is an interconnection line pattern.

8. The method of claim 6,
wherein the upper layer pattern is a contact pattern.

9. The method of claim 4, further comprising:
indicating the evaluation result in a visible manner, when it is evaluated that the predicted height does not satisfy the standard.

10. A design apparatus comprising:
an input unit configured to input a design layout pattern of a semiconductor element with an air gap between interconnection lines;
a classification unit configured to classify interconnection line patterns each comprising a space between the interconnection lines among the design layout patterns, on the basis of characteristics of the space;
a basic amount acquisition unit configured to acquire a basic amount of each classified interconnection line pattern from a shape of the interconnection line pattern classified by the classification unit;
a prediction unit configured to collate data of a correlation between a width of the space and a height of the air gap with the basic amount to predict a position where each air gap is highest and a height of the position, for each classified interconnection line pattern; and
a design layout change unit configured to suitably adjust the arrangement of the interconnection lines in accordance with the predicted position and height.

11. The apparatus of claim 10,
wherein the basic amount acquisition unit acquires the basic amount by use of a size of an inscribed circle which comes in contact with at least two points of pattern edges of the interconnection lines facing each other via the space.

12. The apparatus of claim 10, further comprising:
an evaluation unit configured to evaluate the predicted height on the basis of a preset standard,
wherein the design layout change unit suitably adjusts the arrangement of the interconnection lines in the design layout pattern when the predicted height does not satisfy the standard.

13. The apparatus of claim 12, further comprising:
a display unit configured to display the evaluation result in a visible manner when it is evaluated that the predicted height does not satisfy the standard.

14. A computer-readable recording medium of a design support program, the design support program comprising:
classifying interconnection line patterns each comprising a space between interconnection lines among design layout patterns of a semiconductor element with an air gap between the interconnection lines, on the basis of characteristics of the space;
acquiring a basic amount of the classified interconnection line pattern from a shape of the classified interconnection line pattern;
collating data of a correlation between a width of the space and a height of the air gap with the basic amount, to predict a position where each air gap is highest and a height of the position for each classified interconnection line pattern; and
suitably adjusting the arrangement of the interconnection lines in the design layout pattern in accordance with the predicted position and height.

15. The medium of claim 14,
wherein the basic amount is acquired by using a size of an inscribed circle which comes in contact with at least two points of pattern edges of the interconnection lines facing each other via the space.

16. The medium of claim 14,
wherein the data of the correlation is acquired by measuring the width of the space and the height of the air gap from at least one of an experimental result and a simulation result.

17. The medium of claim 14,
wherein the design support program further comprises evaluating the predicted height on the basis of a preset standard, and
the arrangement of the interconnection lines in the design layout pattern is suitably adjusted when the predicted height does not satisfy the standard.

18. The medium of claim 17,
wherein the arrangement of the interconnection lines in the design layout pattern is suitably adjusted by changing the width of the space, when it is evaluated that the predicted height does not satisfy the standard.

19. The medium of claim 17,
wherein the design layout pattern comprises an upper layer pattern passing above the predicted position, and
the arrangement of the interconnection lines in the design layout pattern is suitably adjusted by moving the upper layer pattern to a position where its contact with the air gap is avoidable, when it is evaluated that the predicted height does not satisfy the standard.

20. The medium of claim 14,
wherein the design support program further comprises indicating the evaluation result in a visible manner, when it is evaluated that the predicted height does not satisfy the standard.
